(19) United States
(12) Patent Application Publication
(10) Pub. No.: US 2024/0169214 A1
(43) Pub. Date: May 23, 2024

(54) KNOWLEDGE GRAPH UPDATING METHOD, APPARATUS, ELECTRONIC DEVICE, STORAGE MEDIUM AND PROGRAM THEREOF

(71) Applicants: Beijing BOE Technology Development Co., Ltd., Beijing (CN); BOE Technology Group Co., Ltd., Beijing (CN)

(72) Inventors: Qiong Wu, Beijing (CN); Boran Jiang, Beijing (CN); Ge Ou, Beijing (CN); Zhenzhong Zhang, Beijing (CN); Shuqi Wei, Beijing (CN); Mengjun Hou, Beijing (CN); Jijing Huang, Beijing (CN)

(73) Assignees: Beijing BOE Technology Development Co., Ltd., Beijing (CN); BOE Technology Group Co., Ltd., Beijing (CN)

(21) Appl. No.: 17/772,736

(22) PCT Filed: Jul. 28, 2021
(86) PCT No.: PCT/CN2021/108959

§ 371 Date: Apr. 28, 2022

(51) Int. Cl. G06N 5/02; G06Q 30/0601

(52) U.S. Cl. CPC G06N 5/02; G06Q 30/0631

(57) ABSTRACT

A knowledge graph updating method, an apparatus, an electronic device, a storage medium and a program thereof, relates to the field of computer technology. The method includes: receiving an updating request of a technical knowledge graph, the updating request includes: a technical-event node of the technical knowledge graph; extracting historical event information corresponding to the technical-event node from the technical knowledge graph; and updating event information of the technical-event node after a current time by using a target-technical-event prediction model; wherein, the target-technical-event prediction model is obtained by training a technical-event prediction model with the historical event information.

### TECHNICAL FIELD

The present disclosure relates to the technical field of computer technology, and particularly, to a knowledge graph updating method, an apparatus, an electronic device, a storage medium and a program thereof.

### BACKGROUND

As a recording method of technology, the technical knowledge graph is a technical representation method based on graph structures, which may realize the technical object with a complete and flexible modeling, and effectively integrated multi-sources and heterogeneous technical information.

### SUMMARY

A knowledge graph updating method, an apparatus, an electronic device, a storage medium and a program thereof are provided by the present disclosure.

A knowledge graph updating method provided by some embodiments of the present disclosure, the method includes:
receiving an updating request of a technical knowledge graph, the updating request includes: a technical-event node of the technical knowledge graph;
extracting historical event information corresponding to the technical-event node from the technical knowledge graph; and
the target-technical-event prediction model is obtained by training a technical-event prediction model with the historical event information.
updating event information of the technical-event node after a current time by using a target-technical-event prediction model.

Optionally, the target-technical-event prediction model is obtained by following steps:
determining an adjacent-event node in the technical knowledge graph adjacent to the technical-event node;
converging the technical-event node and the historical event information of the adjacent-event node, to obtain a converging feature vector; and
training the technical-event prediction model by using the converging feature vector, to obtain the target-technical-event prediction model.

Optionally, when the technical-event prediction model is a technical-connection-event prediction model, the historical event information includes at least one of followings: a head-entity-status attribute, a tail-entity-status attribute, a relationship attribute and a current-time attribute, the converging feature vector includes at least one of followings: a head-entity converging feature vector and a tail-entity converging feature vector;
converging the technical-event node and the historical event information of the adjacent-event node, to obtain the converging feature vector, includes:
converging the technical-event node and the head-entity-status attribute of the adjacent-event node according to the relationship attribute and the current-time attribute, to obtain the head-entity converging feature vector, and converging the technical-event node and the tail-entity-status attribute of the adjacent-event node according to the relationship attribute and the current-time attribute, to obtain the tail-entity converging feature vector.

Optionally, converging the technical-event node and the head-entity-status attribute of the adjacent-event node according to the relationship attribute and the current-time attribute, to obtain the head-entity converging feature vector, and converging the technical-event node and the tail-entity-status attribute of the adjacent-event node according to the relationship attribute and the current-time attribute, to obtain the tail-entity converging feature vector, includes:
the head-entity converging feature vector and the tail-entity converging feature vector may be expressed in forms of following formulas, respectively:

a_{i,t-1}=f₁(s_{i,t-1},s_{j,t-1},r_{ij,t-1},g(t))

a_{j,t-1},=f₂(s_{j,t-1},s_{i,t-1},r_{ji,t-1},g(t))
wherein, i represents a head entity of the technical-event node, j represents a tail entity of the technical-event node, t represents the current time, then a_{i, t-1} represents the head-entity converging feature vector of the head entity i at a t−1 time, s_{i, t-1} represents a head-entity converging attribute of the head entity i at the t−1 time, s_{j, t-1} represents a tail-entity converging attribute of the tail entity j at the t−1 time, r_{ij, t-1} represents a converging relationship attribute from the head entity i to the tail entity j, g(t) represents a time-embedded mapping of the current time t, a_{j, t-1} represents the tail-entity converging feature vector of the tail entity j at the t−1 time, r_{ji, t-1} represents a converging relationship attribute from the tail entity j to the head entity i at the t−1 time.

Optionally, when the technical-event node is a status-updating-event prediction model, time-event information includes: an entity-status attribute, the converging feature vector includes: an event-status converging feature vector;
converging the technical-event node and the historical event information of the adjacent-event node, to obtain the converging feature vector, includes:
acquiring a graph-attention converging feature vector of the technical-event node and the adjacent-event node through a graph-attention converging network; and
converging the technical-event node and the entity-status attribute of the adjacent-event node based on the graph-attention converging feature vector, to obtain the event-status converging feature vector.

Optionally, acquiring the graph-attention converging feature vector of the technical-event node and the adjacent-event node through the graph-attention converging network, includes:
acquiring the graph-attention converging feature vector of the technical-event node and the adjacent-event node shown by following formulas through the graph-attention converging network:

v_{i,t-1}=σ₁(Σ_{j∈N(i)}αᵢⱼw₁v_{j,t-1})

αᵢⱼ=Softmaxⱼ(σ₂(w₃ concat(w₂vᵢ,w₂vₖ)))
wherein, i represents the technical-event node, the j represents the adjacent-event node, N represents a quantity of the adjacent-event node, the t represents the current time, σ₁, σ₂ represent model parameters, w₁, w₂, w₃ represent weight parameters, k represents a kth adjacent-event node, aᵢⱼ represents an event entity between the technical-event node i and the technical-event node j, v_{i, t-1} represents the graph-attention converging feature vector of the technical-event i at the t−1 time, v_{j, t-1} graph-attention converging feature vector of the adjacent-event node at the t−1 time.

Optionally, converging the technical-event node and the entity-status attribute of the adjacent-event node based on the graph-attention converging feature vector, to obtain the event-status converging feature vector, includes:
the event-status converging feature vector represent a following formula:

a_{i,t-1}=f₃(s_{i,t-1},g(t),v_{i,t-1})
wherein, i presents the technical-event node, t represent the current time, then a_{i, t-1} represents the event-status converging feature vector of the technical-event node i at the t−1 time, s_{i, t-1} represents a converging-event-status attribute of the technical-event node i at the t−1 time, v_{i, t-1} represents the graph-attention converging feature vector of the technical-event node i at the t−1 time, g(t) represents the time-embedded mapping of the current time t.

Optionally, when the technical-event node is a purchasing-event node, updating the event information of the technical-event node after the current time by using the target-technical-event prediction model, includes:
predicting a purchasing probability and a purchasing price of the purchasing-event node between the target-technical object and each candidate-purchasing object by using the technical-event prediction model; and
selecting a target-purchasing object from the candidate-purchasing objects according to the purchasing probability and the purchasing price.

A knowledge graph updating apparatus provided by some embodiments of the present disclosure, the apparatus includes:
a receiving module is configured for, receiving an updating request of a technical knowledge graph, the updating request includes: a technical-event node of the technical knowledge graph;
a training module is configured for, extracting historical event information corresponding to the technical-event node from the technical knowledge graph; and
an updating module is configured for, updating event information of the technical-event node after a current time by using a target-technical-event prediction model; wherein, the target-technical-event prediction model is obtained by training a technical-event prediction model with the historical event information.

Optionally, the training module is further configured for:
determining an adjacent-event node in the technical knowledge graph adjacent to the technical-event node;
converging the technical-event node and the historical event information of the adjacent-event node, to obtain a converging feature vector; and
training the technical-event prediction model by using the converging feature vector, to obtain the target-technical-event prediction model.

Optionally, when the technical-event prediction model is a technical-connection-event prediction model, the historical event information includes at least one of followings: a head-entity-status attribute, a tail-entity-status attribute, a relationship attribute and a current-time attribute, the converging feature vector includes at least one of followings: a head-entity converging feature vector and a tail-entity converging feature vector;

The training module is further configured for:
converging the technical-event node and the head-entity-status attribute of the adjacent-event node according to the relationship attribute and the current-time attribute, to obtain the head-entity converging feature vector, and converging the technical-event node and the tail-entity-status attribute of the adjacent-event node according to the relationship attribute and the current-time attribute, to obtain the tail-entity converging feature vector.

Optionally, the training module is further configured for:
the head-entity converging feature vector and the tail-entity converging feature vector may be expressed in forms of following formulas, respectively:

a_{i,t-1}=f₁(s_{i,t-1},s_{j,t-1},r_{ij,t-1},g(t))

a_{j,t-1}=f₂(s_{j,t-1},s_{i,t-1},r_{ji,t-1},g(t))
wherein, i represents a head entity of the technical-event node, j represents a tail entity of the technical-event node, t represents the current time, then a_{i, t-1} represents the head-entity converging feature vector of the head entity i at a t−1 time, s_{i, t-1} represents a head-entity converging attribute of the head entity i at the t−1 time, s_{j, t-1} represents a tail-entity converging attribute of the tail entity j at the t−1 time, r_{ij, t-1} represents a converging relationship attribute from the head entity i to the tail entity j, g(t) represents a time-embedded mapping of the current time t, a_{j, t-1} represents the tail-entity converging feature vector of the tail entity j at the t−1 time, r_{ji, t-1} represents a converging relationship attribute from the tail entity j to the head entity i at the t−1 time.

Optionally, when the technical-event node is a status-updating-event prediction model, time-event information includes: an entity-status attribute, the converging feature vector includes: an event-status converging feature vector;

The training module is further configured for:
acquiring a graph-attention converging feature vector of the technical-event node and the adjacent-event node through a graph-attention converging network; and
converging the technical-event node and the entity-status attribute of the adjacent-event node based on the graph-attention converging feature vector, to obtain the event-status converging feature vector.

Optionally, the training module is further configured for:
acquiring the graph-attention converging feature vector of the technical-event node and the adjacent-event node shown by following formulas through the graph-attention converging network:

v_{i,t-1}=σ₁(Σ_{j∈N(i)}αᵢⱼw₁v_{j,t-1})

αᵢⱼ=Softmaxⱼ(σ₂(w₃ concat(w₂vᵢ,w₂vₖ)))

wherein, i represents the technical-event node, j represents the adjacent-event node, N represents a quantity of the adjacent-event node, t represents the current time, σ₁, σ₂ represent model parameters, w₁, w₂, w₃ represent weight parameters, k represents a kth adjacent-event node, aᵢⱼ represents an event entity between the technical-event node i and the technical-event node j, v_{i, t-1} represents the graph-attention converging feature vector of the technical-event i at the t−1 time, v_{j, t-1} graph-attention converging feature vector of the adjacent-event node at the t−1 time.

Optionally, the training module is further configured for:

the event-status converging feature vector represent a following formula:

a_{i,t-1}=fₛ(s_{i,t-1},g(t),v_{i,t-1})
wherein, i presents the technical-event node, t represent the current time, then a_{i, t-1} represents the event-status converging feature vector of the technical-event node i at the t−1 time, s_{i, t-1} represents a converging-event-status attribute of the technical-event node i at the t−1 time, v_{i, t-1} represents the graph-attention converging feature vector of the technical-event node i at the t−1 time, g(t) represents the time-embedded mapping of the current time t.

Optionally, the updating module is further configured for:
predicting a purchasing probability and a purchasing price of the purchasing-event node between the target-technical object and each candidate-purchasing object by using the technical-event prediction model; and
selecting a target-purchasing object from the candidate-purchasing objects according to the purchasing probability and the purchasing price.

A calculating and processing device provided by some embodiments of the present disclosure, wherein the device includes:
a memory in which a computer-readable code is stored; and
one or more processors, wherein when the computer-readable code is executed by the one or more processors, the calculating and processing device executes the knowledge graph updating method as mentioned above.

A computer program provided by some embodiments of the present disclosure, wherein the computer program includes a computer-readable code that, when executed on a calculating and processing device, causes the calculating and processing device to execute the knowledge graph updating method as mentioned above.

A computer-readable medium provided by some embodiments of the present disclosure, wherein the computer-readable medium stores the knowledge graph updating method as mentioned above.

The above description is merely a summary of the technical solutions of the present disclosure. In order to more clearly know the elements of the present disclosure to enable the implementation according to the contents of the description, and in order to make the above and other purposes, features, and advantages of the present disclosure more apparent and understandable, the particular embodiments of the present disclosure are provided below.

### BRIEF DESCRIPTION OF THE DRAWINGS

In order to more clearly illustrate the technical solutions of the embodiments of the present disclosure or the prior art, the figures that are required to describe the embodiments or the prior art will be briefly introduced below. Apparently, the figures that are described below are embodiments of the present disclosure, and a person skilled in the art can obtain other figures according to these figures without paying creative work.

FIG. 1 schematically shows a flow chart of a knowledge graph updating method provided by some embodiments of the present disclosure:

FIG. 2 schematically shows a first flow chart of a model training method provided by some embodiments of the present disclosure;

FIG. 3 schematically shows a second flow chart of the model training method provided by some embodiments of the present disclosure;

FIG. 4 schematically shows a flow chart of another knowledge graph updating method provided by some embodiments of the present disclosure:

FIG. 5 schematically shows a structural diagram of a knowledge graph updating apparatus provided by some embodiments of the present disclosure:

FIG. 6 schematically shows a block diagram of a calculating and processing device for executing the methods provided by some embodiments of the present disclosure; and

FIG. 7 schematically shows a storage unit for holding or carrying a program code that implements methods provided by some embodiments of the present disclosure.

### DETAILED DESCRIPTION OF THE EMBODIMENTS

In order to make the above objects, features, and advantages of the present disclosure more obvious and understandable, the present disclosure will be described in further detail below with reference to the accompanying drawings and specific implementation ways. Obviously, the described embodiments are some, but not all, embodiments of the present disclosure. Based on the embodiments in the present disclosure, all other embodiments obtained by a person of ordinary skills in the art without inventive efforts fall within the scope of the present disclosure.

In related technologies, an updating process of a technical knowledge graph is by constructing a static technical knowledge graph, integrating patent data and classification data, to realize an expansion and a refinement of classified subject words. However, a defect of the method is that when a new technology patent enters database or when the classification updates, an updated subject word may be only obtained by a training from very beginning, which is inefficient and may not reflect a timing-sequential characteristic of an entity of the technology, and may not represent an evolution and development trend of the technology.

FIG. 1 schematically shows a flow chart of a knowledge graph updating method provided by the present disclosure, an executing subject of the method may be any electronic equipment, for example, the method may be applied to an application with functions such as information displaying, information transmitting and data processing, the method may be executed by a server or terminal equipment of the application. Optionally, the method may be executed by the server, the method includes:

Step 101, receiving an updating request of a technical knowledge graph, the updating request includes: a technical-event node of the technical knowledge graph:

In an embodiment of the present disclosure, a ‘technology’ of the technical knowledge graph refers to a technical scheme with a patent as a carrier, a ‘graph’ refers to regard entity objects like patentees, applicants and patents as nodes, and regard relationships between the entity objects like patent applications, citations, disclosures, transactions and litigations as fringe nodes to perform connections, and related events corresponding to each of the connecting relationships are arranged in a timestamp sequence to construct the technical knowledge graph. The technical-event node refer to any related event between two entity nodes, and the updating request is an updating request of event information of the technical-event node of the technical knowledge graph at a next time which is after a current time.

Specifically, the technical-event node of the technical knowledge graph may be represented by a following formula (1):

S={(hᵢ,rⱼ,tₖ,timeₗ)}∪{hₘ,timeₙ} (1)
wherein, S represents the technical-event node, h is a head, which represents a head entity in a triples (h, r, t), r is a relation which represents a relationship in the triples, t is a tail, which represents a tail entity in a triples, the time represents a timestamp at which the event occurs, the i, the j, the k, the l, the m, and the n are distinguish identifications, for example, the hᵢ and the hₘ may represent two different patentees. In the technical time node, it is arranged from left to right in a timestamp sequence by a connection sign ‘U’, a { } data set is added to the rightmost in sequence when any one element in the triples updates for each time, which includes a timestamp time and the update element for this time, for example, as shown in the formula (1) mentioned above, the head entity at the timestamp time₁ is the hᵢ, at the timestamp timeₙ, the head entity is changed to the hₘ, then it only needs to add a vector {hₘ, timeₙ} to the rightmost, and other elements that are not updated do not need to be added repeatedly. For example, when a company A purchases a patent p at a time t1 may be represented as (h company A, r purchasing, t patent p, t1), the company A sells the patent p to a company B at a time t2 may be represented as (h formular B, t2). Certainly, it is only an example herein, and the presentation way of the specific technical-event node may be set according to practical needs which will not be limited herein.

In some embodiments of the present disclosure, a user may send a specific type of technical-event node between two specific entity nodes to the server through a client of his terminal equipment, to make the sever predict the event information of the entity nodes at the next time after the current time through the knowledge graph updating method provided by the present disclosure, the types of technical time nodes may refer to patent applications patent transactions, patent disputes and so forth. Specifically, it may be set according to practical needs which will not be limited herein.

Step 102, extracting historical event information corresponding to the technical-event node from the technical knowledge graph.

In an embodiment of the present disclosure, each technical-event node of the technical knowledge graph stores event information at different times according to a time sequence. For example, the event information at a time of a year before last year between a patent ownership relationship between some patent technology and a patent holder is a non-holding relationship, the event information is a holding relationship at a time of last year, and the event information is a transferred relationship at a time of this year, therefore, the sever may extract the historical event information of the technical-even node from the technical knowledge graph at the current time to provide a subsequent prediction of the event information at the next time after the current time according to one month, one quarter, one year or such time length in the timestamp.

Specifically, when each technical time node is constructed, a unique entity id and entity status table may be generated, the entity status stores the event information of each technical event entity at different times. A specific vector initialization method such as a zero vector, a transformer encoding of entity-related text and other feature engineering methods may be used on the technical time node to obtain feature vectors. An example of the entity status table is given as follows, taking an entity with three events happened here, each timestamp corresponds to the feature vectors of the entity at the time, the vector dimension of the feature vectors is taken as three dimensions, which are super-parameters of a model structure and may be set as any positive integer:
{“df793a”;
{
1301371434: [0.7,0.4,0.1],
1585468601: [0.8.0.3,0.6],
1617004643: [0.2.0.1,0.6]}}
wherein, “df793a” is the entity id, equivalent column parameters like 1301371434 are time stamps, the triples in the [ ] are status vectors which represent a head entity, a relationship, and a tail entity in sequence, respectively. Certainly, it is only an example herein, specifically, the storage way of the event information may be set according to practical needs which will not be limited herein.

Step 103, updating event information of the technical-event node after a current time by using a target-technical-event prediction model.

In some embodiments of the present disclosure, the technical-event prediction model is a machine-learning model trained by the historical event information corresponding to event nodes in the existing technical knowledge graph. Different types of technical-event node may use a special type model to improve the accuracy of prediction to the event information in the different types of technical-event node, certainly, the different types of technical-event prediction model may select a same type model. Specifically, it may be set according to practical needs which will not be limited herein. Specifically, the historical event information at the current time may be used as a reference standard, and the historical event information may be regarded as a training sample to train a technical-timing prediction model, to obtain a target technical-timing prediction model which may predict the event information of a next time sequence.

In an embodiment of the present disclosure, the server may regard the historical event information of the technical-event node before the current time as a model inputting, so that the target technical-timing prediction model outputs the event information of the technical-event node at the next time after the current time. Then, the event information of the technical-event node of the technical knowledge graph is updated according to the event information obtained by prediction, and the updated technical knowledge graph is sent to the terminal for the user to view.

For example, in an application scenario of patent applicants similarity assessment, the user may appoint a patent applicant A and a patent applicant B as entity objects through the client, and regard the patent similarity as a relationship attribute, so that the triples composed of the patent applicant A, the patent applicant B and the similarity relationship as the technical-event node to be updated in the technical knowledge graph at this time, and send an updating request with the technical-event node to the server through the client. The server, by using the patent similarity of the patent applied by the patent applicant A and the patent applicant B in the past time as the historical event information, and after obtaining the target-technical-event prediction model by training the technical-event prediction model through the historical event information, inputs the historical event information into the target-technical event prediction model to output a predicted patent similarity of the applied patent of the patent applicant A and the patent applicant B at the next time. Finally, updating the patent similarity of the technical-event node of the technical knowledge graph at the next time according to the predicted patent similarity and sending it to the client. The user may view the predicted patent similarity of the applied patent of the patent applicant A and the patent applicant B at the next time through a displaying interface of the client.

In an application scenario of finding the patent by a patent competitor, the user may appoint a patent applicant C and one or more patent applicants D as the entity objects through the client, the patent applicant C may be the user himself, the patent applicant D may be a potential user has a patent competition relationship with the patent applicant C, therefore, regarding the patent applicant C and the patent applicant D as the entity objects, the patent competition relationship as the relationship attribute, so that regarding the triples composed of the patent applicant C, the patent applicant D and the patent competition relationship as the technical-event node to be updated in the technical knowledge graph at this time, and sending an updating request with the technical-event node to the server through the client. The sever, by using the patent application information with the competition relationship applied by the patent applicant C and the patent applicant D in the past time as the historical event information, and after obtaining the target-technical-event prediction model by training the technical-event prediction model through the historical event information, inputting the historical event information to the target-technical-event prediction model to output a predicted probability of the patent competition relationship exists in the patent applied by the patent applicant C and the patent applicant D at the next time. Finally, updating the patent competition relationship of the technical-event node of the technical knowledge graph at the next time according to the predicted probability and sending it to the client. The user may view the predicted probability of the patent competition relationship occurs between the patent applicant C and each of the patent applicants D at the next time through the displaying interface of the client.

In an application scenario of a patent digging, the user may appoint an inventor E and one or more technical field classifications F as the entity objects, regard the patent application relationship as the relationship attribute, therefore, regarding the triples composed of the inventor E, the technical field classification F, and the patent application relationship as the technical-event node, and sending an updating request with the technical-event node to the server through the client. The server, by using the event information with the patent application relationship of the inventor E and the technical field classification F as the historical event information, and after obtaining the target-technical-event prediction model by training the technical-event prediction model through the historical event information, inputs the historical event information to the target-technical-event prediction model to output a predicted probability of the inventor E publishes a patent in the technical field classification F at the next time. Finally, updating the patent application relationship of the technical-event node of the technical knowledge graph at the next time according to the predicted probability and sending it to the client. The user may view the predicted probability of the inventor E publishes a patent in each of the technical field classifications F through the displaying interface of the client.

In an application scenario of a patent dispute warning, the user may appoint a patentee G and one or more patentee H as the entity objects through the client, regard a patent dispute relationship as the relationship attribute, therefore, regarding the triples composed of the patentee G, the patentee H, and the patent dispute relationship as the technical-event node, and sending an updating request with the technical-event node to the sever through the client. The sever, by using a historical patent dispute record between the patentee G and the patentee H as the historical event information, and after obtaining the target-technical-event prediction model by training the technical-event prediction model through the historical event information, inputs the historical event information to the target-technical-event prediction model to output a predicted probability of a patent dispute occurs between the patentee G and the patentee H at the next time. Finally, updating the patent application relationship of the technical-event node of the technical knowledge graph at the next time according to the predicted probability and sending it to the client. The user may view the predicted probability of the patent dispute relationship occurs between the patentee G and each of the patentees H at the next time through the displaying interface of the client.

In an application scenario of a patent application trend prediction, the user may appoint a patent applicant I and one or more patent applicants J as the entity objects through the client, and regard a patent reference relationship as the relationship attribute. Therefore, regarding the triples composed of the patent applicant I, the patent applicant J, and the patent reference relationship as the technical-event node, and sending an updating request with the technical-event node to the sever through the client. The sever, by using a historical patent reference record between the patent applicant I and the patent applicant J as the historical event information, and after obtaining the target-technical-event prediction model by training the technical-event prediction model through the historical event information, inputs the historical event information to the target-technical-event prediction model to output a predicted probability of a patent reference relationship occurs between the patent applicant I and the patent applicant J at the next time. Finally, updating the patent application relationship of the technical-event node of the technical knowledge graph at the next time according to the predicted probability and sending it to the client. The user may view the predicted probability of the patent reference relationship occurs between the patent applicant I and each of the patent applicants J at the next time through the displaying interface of the client.

Certainly, what is mentioned above is only an example, specifically, the technical-event node and the historical event information selected by the technical knowledge graph during the updating process may be carried out according to practical needs which will not be limited herein.

The embodiment of the present disclosure trains to update the technical-event prediction model based on the historical event information of the technical-event node which is required to update, therefore, the updated target-technical-event prediction model may merely update the event information of the technical-event node which is required to update after the current time, it is not necessary to update the information of all nodes in the entire technical knowledge graph, which reduces the amount of data processing required for updating the technical knowledge graph and improves the updating efficiency of the technical knowledge graph.

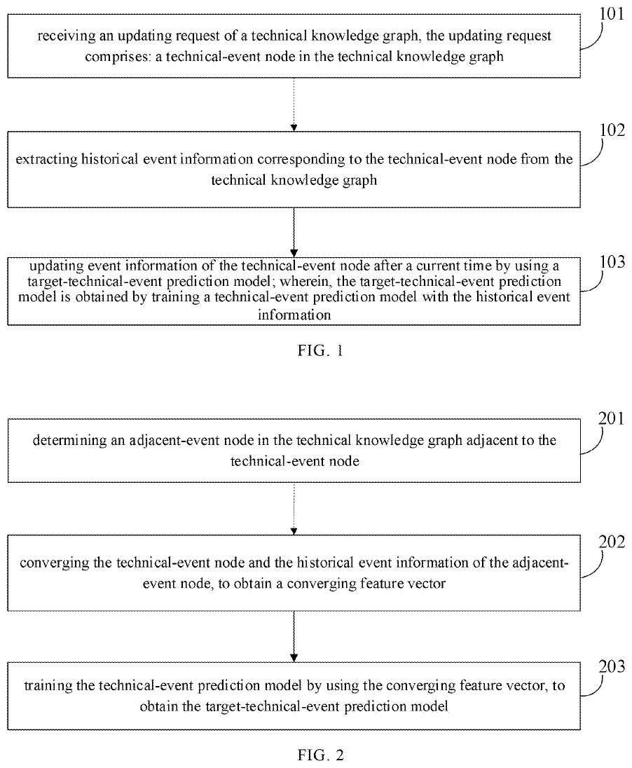

Optionally, referring to FIG. 2, the target-technical-event prediction model may be obtained by steps 201 to 203 below:

Step 201, determining an adjacent-event node in the technical knowledge graph adjacent to the technical-event node;

In an embodiment of the present disclosure, the adjacent-event node refers to an event node with an adjacent relationship with the technical-event node in the technical knowledge graph. It may be understood that there is a certain relationship between the event information of the technical-event node and the adjacent-event node connected to it when the technical information changes, therefore, the feature vector of the technical-event node may be represented by introducing the historical event information of the adjacent-event node, so that the model prediction may consider the influence of the event updating to the technical-event node by the adjacent-event node.

Step 202, converging the technical-event node and the historical event information of the adjacent-event node, to obtain a converging feature vector; and

In an embodiment of the present disclosure, due to a certain redundant content may exist in the event information between the adjacent-event node and the technical-event node, therefore, converging the historical event information of the technical-event node and the adjacent-event node by a converging processing way, so that when the obtained converging feature vector is simplified as much as possible, it may still give consideration to the historical event information of the technical-event node and the adjacent-event node.

Step 203, training the technical-event prediction model by using the converging feature vector, to obtain the target-technical-event prediction model.

In an embodiment of the present disclosure, training the technical-event prediction model by using the converging feature vector as the feature vector representing the technical-event node as a model inputting, so that the target-technical-event prediction model obtained by training may learn an influence factor brought by the event information from the adjacent-event node to the technical-event node, thereby improving the accuracy of the event information prediction.

In some embodiments of the present disclosure, a cross entropy loss function shown in a formula (2) below may be used as a standard of whether the model training is completed or not:

$${L}_{θ} ( y , \tilde{y} ) = \frac{1}{N} {\sum }_{i} ( - {\sum }_{c = 1}^{K} {y}_{ic} log ( {p}_{ic} ) ) \qquad ( 2 )$$

Wherein, N is a quantity of the technical-event node, K represents a quantity of the event type, y represents standard-event information, ŷ represents predicted event information, i represents the technical-event node, c represents a number of the event type, then y_{ic} represents the technical-event node i is the standard-event information corresponding to the event type c, p_{ic} represents the technical-event node i is the predicted event information corresponding to the event type c.

Specifically, a small batch of random-drop methods may be used to train the network each batch of data is composed of a set number of events, and a training iteration is stopped until a set number of iterations or the model convergences to a loss value which is less than a set threshold, storing model parameters and finish the model training.

Optionally, when the technical-event prediction model is a technical-connection-event prediction model, the historical event information includes at least one of followings: a head-entity-status attribute, a tail-entity-status attribute, a relationship attribute and a current-time attribute, the converging feature vector includes at least one of followings: a head-entity converging feature vector and a tail-entity converging feature vector; the step 1032 may include: converging the technical-event node and the head-entity-status attribute of the adjacent-event node according to the relationship attribute and the current-time attribute, to obtain the head-entity converging feature vector, and converging the technical-event node and the tail-entity-status attribute of the adjacent-event node according to the relationship attribute and the current-time attribute, to obtain the tail-entity converging feature vector.

In an embodiment of the present disclosure, the converging network of the event information may use a multi-layer sensing machine structure or other neural network structures. Due to the relationship attribute between the head entity and the tail entity in a connection event has direction, for example, when the head entity purchases a technology patent from the tail entity and the tail entity purchases a technology patent from the head entity, the relationship attributes are both purchasing relationships, but belong to two different events. Therefore, in order to avoid the event information with different relationship directions but the same relationship attributes from being influenced by error convergence on subsequent model prediction, so that when converging the features, an individual converging feature vector is constructed for the head entity and the tail entity, to obtain the head-entity converging feature vector and the tail-entity converging feature vector.

Specifically, for the technical-connection-event prediction model, it may use the multi-layer sensing network and its neural network structure or other neural network structures, and the technical-connection-event prediction model may be in a form as shown in a formular (3) below:

xₗ₊₁=σ(wxₗ+b) (3)

Wherein, w, b and σ are the model parameters, respectively, xₗ is the historical event information and xₗ₊₁ is the event information obtained by the prediction of the next time after the current time.

Optionally, the step 202 may include: the head-entity converging feature vector and the tail-entity converging feature vector may be expressed in forms of following formulas, respectively:

a_{i,t-1}=f₁(s_{i,t-1},s_{j,t-1},r_{ij,t-1},g(t))

a_{j,t-1}=f₂(s_{j,t-1},s_{i,t-1},r_{ji,t-1},g(t))
wherein, i represents a head entity of the technical-event node, j represents a tail entity of the technical-event node, t represents the current time, then a_{i, t-1} represents the head-entity converging feature vector of the head entity i at a t−1 time, s_{i, t-1} represents a head-entity converging attribute of the head entity i at the t−1 time, s_{j, t-1} represents a tail-entity converging attribute of the tail entity j at the t−1 time, r_{ij, t-1} represents a converging relationship attribute from the head entity i to the tail entity j, g(t) represents a time-embedded mapping of the current time t, a_{j, t-1} represents the tail-entity converging feature vector of the tail entity j at the t−1 time, r_{ji, t-1} represents a converging relationship attribute from the tail entity j to the head entity i at the t−1 time.

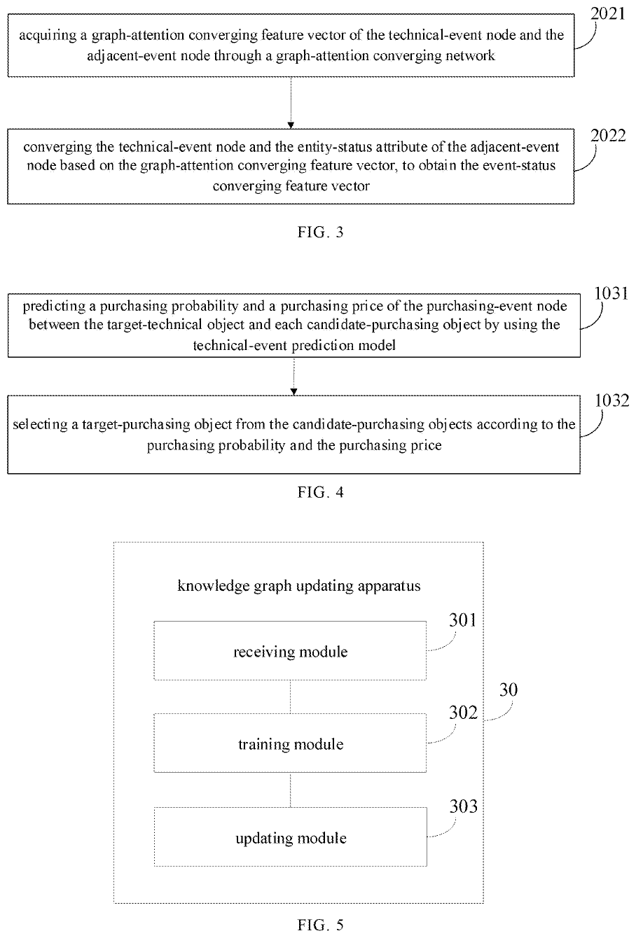

Optionally, when the technical-event node is a status-updating-event prediction model, time-event information includes: an entity-status attribute, the converging feature vector includes: an event-status converging feature vector. Referring to FIG. 3, the step 202 may include:

Step 2021, acquiring a graph-attention converging feature vector of the technical-event node and the adjacent-event node through a graph-attention converging network; and

Step 2022, converging the technical-event node and the entity-status attribute of the adjacent-event node based on the graph-attention converging feature vector, to obtain the event-status converging feature vector.

In an embodiment of the present disclosure, a status updating event refers to an event changed in a technology entity of the event information of the technical-event node. Therefore, the influence degree from the adjacent-event node to the technical-event node may be adjusted by introducing the graph-attention converging feature vector, so that it may avoid the inaccurate prediction results caused by excessive influence from the adjacent-event node to the technical-event nodes.

Specifically, a status-updating-time-prediction model may use a cyclic neural network, such as a long-short memory network or a gated cyclic unit network, which may be expressed in a form of a formula (4) below:

s_{i,t}=RNN_{c}_{ᵢ}(s_{i,t-1},a_{i,t-1}) (4)

Wherein, s_{i, t} represents the event status information at the next time t after the current time, s_{i, t-1} represents the event status information at the current time t−1, a_{i, t-1} represents the converging feature vector of the technical-event node i at the t−1 time, cᵢ represents the entity type of the technical-event node i.

Optionally, the step 10321 may include: acquiring the graph-attention converging feature vector of the technical-event node and the adjacent-event node shown by following formulas through the graph-attention converging network:

v_{i,t-1}=σ₁(Σ_{j∈N(i)}αᵢⱼw₁v_{j,t-1})

αᵢⱼ=Softmaxⱼ(σ₂(w₃ concat(w₂vᵢ,w₂vₖ)))
wherein, i represents the technical-event node, j represents the adjacent-event node. N represents a quantity of the adjacent-event node, t represents the current time, σ₁, σ₂ represent model parameters, w₁, w₂, w₃ represent weight parameters, k represents a kth adjacent-event node, aᵢⱼ represents an event entity between the technical-event node i and the technical-event node j, v_{i, t-1} represents the graph-attention converging feature vector of the technical-event i at the t−1 time, v_{j, t-1} graph-attention converging feature vector of the adjacent-event node at the t−1 time.

Optionally, the step 10322 may include: the event-status converging feature vector represents a formula below:

a_{i,t-1}=f₃(s_{i,t-1},g(t),v_{i,t-1})
wherein, i presents the technical-event node, t represent the current time, then a_{i, t-1} represents the event-status converging feature vector of the technical-event node i at the t−1 time, s_{i, t-1} represents a converging-event-status attribute of the technical-event node i at the t−1 time, v_{i, t-1} represents the graph-attention converging feature vector of the technical-event node i at the t−1 time, g(t) represents the time-embedded mapping of the current time t.

Optionally, when the technical-event node is a purchasing-event node, referring to FIG. 4, the step 103 may include:

Step 1031, predicting a purchasing probability and a purchasing price of the purchasing-event node between the target-technical object and each candidate-purchasing object by using the technical-event prediction model.

In an embodiment of the present disclosure, the target-technical object is a provider to a technology patent, and the candidate-purchasing object may be a potential technology buyer selected by the user artificially, certainly, the candidate-purchasing object may be determined by the entity object of the system which has a connection relationship between the history and the target-technical object. Therefore, the event information of the purchasing-event node may be preset to include that, based on the purchasing price, the target-technical-event prediction model may output the probability of reaching the purchasing relationship and the purchasing price between the target-technical object with each of the candidate-purchasing objects.

Step 1032, selecting a target-purchasing object from the candidate-purchasing objects according to the purchasing probability and the purchasing price.

In an embodiment of the present disclosure, the purchasing probability and the purchasing price may be multiplied to obtain an expected purchasing price of each of the candidate-purchasing objects, the expected purchasing prices may be arranged in a descending sequence, and then the first one or three candidate-purchasing objects with equal quantities are regarded as the target-purchasing object, so that the user may get to know the potential buyer with large return conveniently.

In the embodiment of the present disclosure, after the banalization of the initial infrared image, the irrelevant background image area in the initial infrared image is removed, to reduce the interference of irrelevant image content on subsequent key point recognition and improve the accuracy of the key point recognition.

FIG. 5 schematically shows a structural diagram of a knowledge graph updating apparatus 30 provided by the present disclosure, the apparatus includes:
a receiving module 301 is configured for, receiving an updating request of a technical knowledge graph, the updating request includes: a technical-event node of the technical knowledge graph;
a training module 302 is configured for, extracting historical event information corresponding to the technical-event node from the technical knowledge graph; and
an updating module 303 is configured for, updating event information of the technical-event node after a current time by using a target-technical-event prediction model; wherein, the target-technical-event prediction model is obtained by training a technical-event prediction model with the historical event information.

Optionally, the training module 302 is further configured for:
determining an adjacent-event node in the technical knowledge graph adjacent to the technical-event node;
converging the technical-event node and the historical event information of the adjacent-event node, to obtain a converging feature vector; and
training the technical-event prediction model by using the converging feature vector, to obtain the target-technical-event prediction model.

Optionally, when the technical-event prediction model is a technical-connection-event prediction model, the historical event information includes at least one of followings: a head-entity-status attribute, a tail-entity-status attribute, a relationship attribute and a current-time attribute, the converging feature vector includes at least one of followings: a head-entity converging feature vector and a tail-entity converging feature vector;

The training module 302 is further configured for:
converging the technical-event node and the head-entity-status attribute of the adjacent-event node according to the relationship attribute and the current-time attribute, to obtain the head-entity converging feature vector, and converging the technical-event node and the tail-entity-status attribute of the adjacent-event node according to the relationship attribute and the current-time attribute, to obtain the tail-entity converging feature vector.

Optionally, the training module 302 is further configured for:
the head-entity converging feature vector and the tail-entity converging feature vector may be expressed in forms of following formulas, respectively:

a_{i,t-1}=f₁(s_{i,t-1},s_{j,t-1},r_{ij,t-1},g(t))

a_{j,t-1}=f₂(s_{j,t-1},s_{i,t-1},r_{ji,t-1},g(t))
wherein, i represents a head entity of the technical-event node, j represents a tail entity of the technical-event node, t represents the current time, then a_{i, t-1} represents the head-entity converging feature vector of the head entity i at a t−1 time, s_{i, t-1} represents a head-entity converging attribute of the head entity i at the t−1 time, s_{j, t-1} represents a tail-entity converging attribute of the tail entity j at the t−1 time, r_{ij, t-1} represents a converging relationship attribute from the head entity i to the tail entity j, g(t) represents a time-embedded mapping of the current time t, a_{j, t-1} represents the tail-entity converging feature vector of the tail entity j at the t−1 time, r_{ji, t-1} represents a converging relationship attribute from the tail entity j to the head entity i at the t−1 time.

Optionally, when the technical-event node is a status-updating-event prediction model, time-event information includes: an entity-status attribute, the converging feature vector includes: an event-status converging feature vector;

The training module 302 is further configured for:
acquiring a graph-attention converging feature vector of the technical-event node and the adjacent-event node through a graph-attention converging network; and
converging the technical-event node and the entity-status attribute of the adjacent-event node based on the graph-attention converging feature vector, to obtain the event-status converging feature vector.

Optionally, the training module 302 is further configured for:
acquiring the graph-attention converging feature vector of the technical-event node and the adjacent-event node shown by following formulas through the graph-attention converging network:

v_{i,t-1}=σ₁(Σ_{j∈N(i)}αᵢⱼw₁v_{j,t-1})

αᵢⱼ=Softmaxⱼ(σ₂(w₃ concat(w₂vᵢ,w₂vₖ)))

wherein, i represents the technical-event node, j represents the adjacent-event node, N represents a quantity of the adjacent-event node, t represents the current time, σ₁, σ₂ represent model parameters, w₁, w₂, w₃ represent weight parameters, k represents a kth adjacent-event node, aᵢⱼ represents an event entity between the technical-event node i and the technical-event node j, v_{i, t-1} represents the graph-attention converging feature vector of the technical-event i at the t−1 time, v_{j, t-1} graph-attention converging feature vector of the adjacent-event node at the t−1 time.

Optionally, the training module 302 is further configured for:

the event-status converging feature vector represents a following formula:

a_{i,t-1}=fₛ(s_{i,t-1},g(t),v_{i,t-1})
wherein, i presents the technical-event node, the t represent the current time, then a_{i, t-1} represents the event-status converging feature vector of the technical-event node i at the t−1 time, s_{i, t-1} represents a converging-event-status attribute of the technical-event node i at the t−1 time, v_{i, t-1} represents the graph-attention converging feature vector of the technical-event node i at the t−1 time, the g(t) represents the time-embedded mapping of the current time t.

Optionally, the updating module 303 is further configured for:
predicting a purchasing probability and a purchasing price of the purchasing-event node between the target-technical object and each candidate-purchasing object by using the technical-event prediction model; and
selecting a target-purchasing object from the candidate-purchasing objects according to the purchasing probability and the purchasing price.

The embodiment of the present disclosure trains to update the technical-event prediction model based on the historical event information of the technical-event node which is required to update, therefore, the updated target-technical-event prediction model may merely update the event information of the technical-event node which is required to update after the current time, it is not necessary to update the information of all nodes in the entire technical knowledge graph, which reduces the amount of data processing required for updating the technical knowledge graph and improves the updating efficiency of the technical knowledge graph.

The embodiment of the apparatus described above is only schematic, wherein the components described separately may or may not physically apart, the component as the unit display may or may not be a physical component, which may be in one place or it may be distributed to a plurality of network units. Part of or all the modules may be selected to implement the purpose of the embodiment according to practical needs. Ordinary technical personnel in this field may understand and implement it without paying creative labor.

The individual component embodiments of this disclosure may be implemented in hardware, in software modules running on one or more processors, or in a combination of them. Those skilled in the field should understand that a microprocessor or digital signal processor (DSP) may be used in practice to implement some or all of the functions of some or all of the components of a computational processing device according to this disclosed embodiment. This exposure may also be implemented as devices or device programs (for example, computer programs and computer program products) used to perform some or all of the methods described here. Such implementation the program exposed may be stored on computer readable media or may take the form of one or more signals. Such signals may be downloaded from Internet sites, provided on carrier signals, or in any other form.

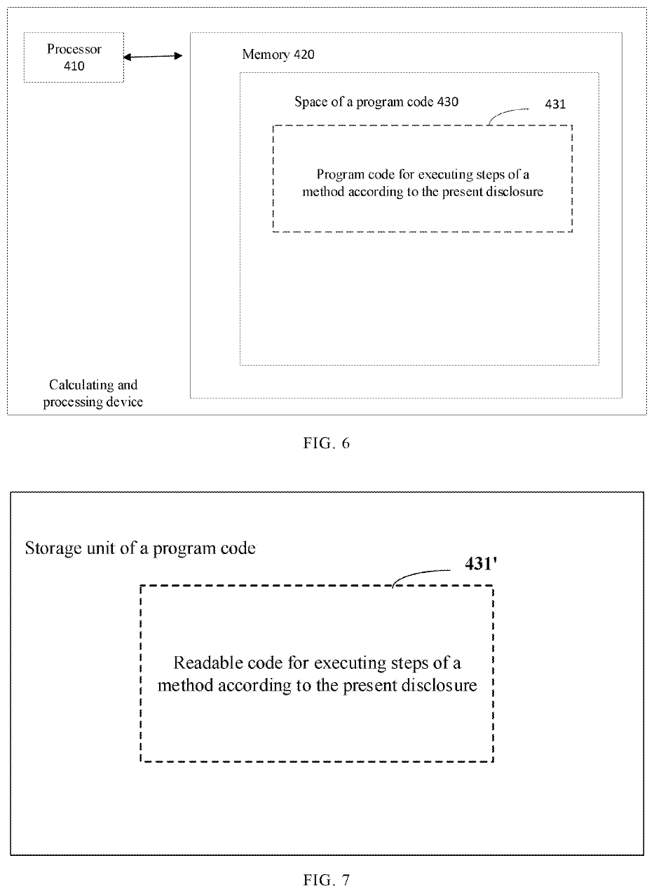

For example. FIG. 6 shows a calculating and processing device that may be implemented according to the method provided by the present disclosure. The calculating and processing device traditionally includes a processor 410 and a computer program product or computer readable medium in the form of a memory 420. The Memory 420 may be an electronic memory such as flash memory, EEPROM (electrically erasable programmable Read-only memory), EPROM, hard disk, or ROM. Memory 420 has storage 430 of program code 431 for performing any of the method steps described above. For example, storage 430 for program code could include individual program code 431 for implementing the various steps in the method above. The program code may be read from or written to one or more computer program products. These computer program products include program code carriers such as hard disks, compact disks (CDS), memory cards, or floppy disks. Such computer program products are usually portable or stationary storage units as described in FIG. 7. The storage unit may have a storage segment, storage space, etc., arranged similarly to memory 420 in the computational processing device shown in FIG. 6. The program code may, for example, be compressed in an appropriate form. Typically, the storage unit includes computer-readable code 431′, that is, code that may be read by, for example, a processor such as 410, which, when executed by a calculating and processing device, causes the compute processing device to perform the steps in the method described above.

It should be understood that the steps in the attached flow chart are shown in sequence as indicated by the arrows, but they are not necessarily carried out in the sequence indicated by the arrows. Unless explicitly stated in the description, there is no strict order in which these steps may be performed, and they are capable to be performed in any other sequences. Moreover, at least part of the steps in the attached flow chart may include multiple sub-steps or stages, these sub-steps or stages are not necessarily executed at the same time, but may be executed at different times, and their execution sequence is not necessarily sequential. It may be performed alternately with other steps or at least part of a sub-step or stage of another step.

The term ‘one embodiment’, ‘an embodiment’, or ‘one or more embodiments’ herein means that the particular features, structures, or features described in combination with embodiments are included in at least one embodiment disclosed herein. Also, note that the examples of words ‘in an embodiment’ here do not necessarily all refer to the same embodiment.

A great deal of detail is provided in the manual provided here. However, it is understood that this disclosed embodiment may be practiced without such specific details. In some instances, known methods, structures and techniques are not detailed so as not to obscure the understanding of this specification.

In a claim, no reference symbol between parentheses shall be constructed to restrict the claim. The word ‘include’ does not exclude the existence of elements or steps not listed in the claim. The word ‘one’ or ‘one’ before a component does not preclude the existence of more than one such component. This exposure may be implemented with the help of hardware including several different components and with the help of properly programmed computers. In listing the unit claims of several devices, several of these devices may be embodied by the same hardware item. The use of the words first, second, and third does not indicate any order. These words may be interpreted as names.

Finally, it should be noted that the above embodiments are only used to illustrate, and not to limit, the disclosed technical solution; notwithstanding the detailed description of this disclosure with reference to the foregoing embodiments, ordinary technical personnel in the field should understand that they may still modify the technical solutions recorded in the foregoing embodiments, or make equivalent substitutions to some of the technical features thereof; such modifications or substitutions shall not separate the essence of the corresponding technical solutions from the spirit and scope of the technical solutions of the disclosed embodiments.

1. A knowledge graph updating method, wherein the method comprises:
receiving an updating request of a technical knowledge graph, the updating request comprises: technical-event node of the technical knowledge graph;
extracting historical event information corresponding to the a technical-event node from the technical knowledge graph; and
updating event information of the technical-event node after a current time by using a target-technical-event prediction model; wherein, the target-technical-event prediction model is obtained by training a technical-event prediction model with the historical event information.

2. The method according to claim 1, wherein, the target-technical-event prediction model is obtained by following steps:
determining an adjacent-event node in the technical knowledge graph adjacent to the technical-event node;
converging the technical-event node and the historical event information of the adjacent-event node, to obtain a converging feature vector; and
training the technical-event prediction model by using the converging feature vector, to obtain the target-technical-event prediction model.

3. The method according to claim 2, wherein when the technical-event prediction model is a technical-connection-event prediction model, the historical event information comprises at least one of followings: a head-entity-status attribute, a tail-entity-status attribute, a relationship attribute and a current-time attribute, the converging feature vector comprises at least one of followings: a head-entity converging feature vector and a tail-entity converging feature vector;
converging the technical-event node and the historical event information of the adjacent-event node, to obtain the converging feature vector, comprises:
converging the technical-event node and the head-entity-status attribute of the adjacent-event node according to the relationship attribute and the current-time attribute, to obtain the head-entity converging feature vector, and converging the technical-event node and the tail-entity-status attribute of the adjacent-event node according to the relationship attribute and the current-time attribute, to obtain the tail-entity converging feature vector.

4. The method according to claim 3, wherein converging the technical-event node and the head-entity-status attribute of the adjacent-event node according to the relationship attribute and the current-time attribute, to obtain the head-entity converging feature vector, and converging the technical-event node and the tail-entity-status attribute of the adjacent-event node according to the relationship attribute and the current-time attribute, to obtain the tail-entity converging feature vector, comprises:
the head-entity converging feature vector and the tail-entity converging feature vector may be expressed in forms of following formulas, respectively:
a_{i,t-1}=f₁(s_{i,t-1},s_{j,t-1},r_{ij,t-1},g(t)))
a_{j,t-1}=f₂(s_{j,t-1},s_{i,t-1},r_{ji,t-1},g(t))
wherein, i represents a head entity of the technical-event node, j represents a tail entity of the technical-event node, t represents the current time, then a_{i, t-1} represents the head-entity converging feature vector of the head entity i at a t−1 time, s_{i, t-1} represents a head-entity converging attribute of the head entity i at the t−1 time, s_{j, t-1} represents a tail-entity converging attribute of the tail entity j at the t−1 time, r_{ij, t-1} represents a converging relationship attribute from the head entity i to the tail entity j, g(t) represents a time-embedded mapping of the current time t, a_{j, t-1} represents the tail-entity converging feature vector of the tail entity j at the t−1 time, r_{ji, t-1} represents a converging relationship attribute from the tail entity j to the head entity i at the t−1 time.

5. The method according to claim 3, wherein, when the technical-event node is a status-updating-event prediction model, time-event information comprises: an entity-status attribute, the converging feature vector comprises: an event-status converging feature vector;
converging the technical-event node and the historical event information of the adjacent-event node, to obtain the converging feature vector, comprises:
acquiring a graph-attention converging feature vector of the technical-event node and the adjacent-event node through a graph-attention converging network; and
converging the technical-event node and the entity-status attribute of the adjacent-event node based on the graph-attention converging feature vector, to obtain the event-status converging feature vector.

6. The method according to claim 5, wherein, acquiring the graph-attention converging feature vector of the technical-event node and the adjacent-event node through the graph-attention converging network, comprises:
acquiring the graph-attention converging feature vector of the technical-event node and the adjacent-event node shown by following formulas through the graph-attention converging network:
v_{i,t-1}=σ₁(Σ_{j∈N(i)}aᵢⱼw₁v_{j,t-1})
aᵢⱼ=Softmaxⱼ(σ₂(w₃ concat(w₂vᵢ,w₂vₖ)))
wherein, i represents the technical-event node, j represents the adjacent-event node, N represents a quantity of the adjacent-event node, the t represents the current time, σ₁,σ₂ represent model parameters, w₁, w₂, w₃ represent weight parameters, the k represents a kth adjacent-event node, aᵢⱼ represents an event entity between the technical-event node i and the technical-event node j, v_{i, t-1} represents the graph-attention converging feature vector of the technical-event i at the t−1 time, v_{j, t-1} graph-attention converging feature vector of the adjacent-event node at the t−1 time.

7. The method according to claim 5, wherein converging the technical-event node and the entity-status attribute of the adjacent-event node based on the graph-attention converging feature vector, to obtain the event-status converging feature vector, comprises:
the event-status converging feature vector represents a formula below:
a_{i,t-1}=f₃(s_{i,t-1},g(t),v_{t,t-1})
wherein, i presents the technical-event node, t represent the current time, then a_{i, t-1} represents the event-status converging feature vector of the technical-event node i at the t−1 time, s_{i, t-1} represents a converging-event-status attribute of the technical-event node i at the t−1 time, v_{i, t-1} represents the graph-attention converging feature vector of the technical-event node i at the t−1 time, g(t) represents the time-embedded mapping of the current time t.

8. The method according to claim 1, wherein, when the technical-event node is a purchasing-event node, updating the event information of the technical-event node after the current time by using the target-technical-event prediction model, comprises:
predicting a purchasing probability and a purchasing price of the purchasing-event node between the target-technical object and each of the candidate-purchasing objects by using the technical-event prediction model; and
selecting a target-purchasing object from the candidate-purchasing objects according to the purchasing probability and the purchasing price.

9. A knowledge graph updating apparatus, wherein the apparatus comprises:
a receiving module is configured for, receiving an updating request of a technical knowledge graph, the updating request comprises: a technical-event node of the technical knowledge graph;
a training module is configured for, extracting historical event information corresponding to the technical-event node from the technical knowledge graph; and
an updating module is configured for, updating event information of the technical-event node after a current time by using a target-technical-event prediction model; wherein, the target-technical-event prediction model is obtained by training a technical-event prediction model with the historical event information.

10. A calculating and processing device, wherein the device comprises:
a memory in which a computer-readable code is stored; and
one or more processors, wherein when the computer-readable code is executed by the one or more processors, the calculating and processing device executes the knowledge graph updating method according to claim 1.

11. A computer program, wherein the computer program comprises a computer-readable code that, when executed on a calculating and processing device, causes the calculating and processing device to execute the knowledge graph updating method according to claim 1.

12. A computer-readable medium, wherein the computer-readable medium stores the knowledge graph updating method according to claim 1.
